(19) United States
(12) Patent Application Publication
(10) Pub. No.: US 2003/0014542 A1
(43) Pub. Date: Jan. 16, 2003

(54) Method for deriving a network name

(76) Inventors: Brian R. Haug, Chandler, AZ (US); Changguan Fan, Chandler, AZ (US); Meera Desikamani, Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/905,624

(22) Filed: Jul. 13, 2001

(51) Int. Cl. G06F 15/16

(52) U.S. Cl. 709/245; 709/217

(57) ABSTRACT

The present disclosure relates to a method, apparatus and system for determining or deriving a network name.

### BACKGROUND

1. Related Applications

The claim subject matter herein may be used in conjunction with another of the following patent applications, which the assignee of this application has co-pending, entitled “Authentication Protocol” and/or “Generally Provisioning an Appliance.”

2. Field

The present disclosure relates to determining or deriving a network name, or the like.

3. Background Information

Typically, each device on a network is assigned, dynamically or statically, an individual address and/or name. The device's network address is the address used to route information along the network to the device. Often, this address is primarily utilized by other devices on the network. For example, which the claimed subject matter is not limited to, an Internet Protocol network address (IP address) typically consists of a 32-bit number, such as, for example 198.137.240.92. Postel, J. B., ed. 1981a. “Internet Protocol,” RFC791, 45 pages (September). In another example, a telephone number, such as, for example, 202-456-1414, might conceivably be used as a network address. One skilled in the art will realize that different network architectures and protocols will utilize different network addressing schemes.

In addition, a network device is also typically assigned, dynamically or statically, a name. This network name, also referred to as a fully qualified domain name, is often primarily used by humans and is often translated by the network device or user into the corresponding network address. For example, a network name may be “www.whitehouse.gov” and would correspond to the network address 198.137.240.92. To continue the telephone example, the network name “White House Switchboard” would correspond to the network address 202-456-1414.

Network names generally have a format that is hierarchal in nature. As a result, network names have a taxonomy, which breaks the network name into two main parts. The first part, for purposes of this document, is referred to as the domain name. The domain name defines the subsection or domain of the network where the network device is located. For example, “whitehouse.gov” is the domain name of “www.whitehouse.gov.” It informs us that the device is on the subsection of the Internet blocked off for the White House. In the telephone example, “White House” is the domain name. It informs us which switchboard is being called. The other part of the network name is referred to, for purposes of this document, as the host name. The host name defines the specific network node in the subsection of the network. For example, “www” is the host name of “www.whitehouse.gov.” It specifies the web server, as opposed to, such as, for example, the mail server. In the telephone example, the host name is “Switchboard.” It specifies the main switchboard of the White House, as opposed to the President's personal phone. When the host name and domain name are combined, they form a fully qualified domain name. In this context, a fully qualified domain name provides sufficient information to identify a particular network node or device. For example, the host name, “www,” and the domain name, “whitehouse.gov,” combine to form the fully qualified domain name “www.whitehouse.gov.” Of course, one skilled in the art will understand that other network protocols may be used and can be defined using a similar taxonomy. One skilled in the art will also realize that benefits may be obtained by assigning multiple host names to a single network device or, possibly, assigning a single host name to multiple network devices; therefore, the claimed subject matter is not limited to a specific style of network name assignment or an overly formalized network nomenclature.

Presently, in order for a first network device to make a connection to a second network device, the first network device must know either the network address or the fully qualified domain name of the second network device. Often, this information is provided substantially by a user. This places the onus of determining either the network address or fully qualified domain name upon the user. In this context, the user may be any human who interacts with the device, such as, for example, the end user or administrator of the network device or a designer of a series of instructions, which the network device performs.

This information, if a limited number of network devices are to be accessed, might possibly be preconfigured into a device by, such as, for example, a manufacturer, distributor or designer (hereafter, “manufacturer”). However, by preconfiguring a device in such a way, the manufacturer would have to incur the inconvenience and expense of maintaining many separate “builds” for its various customers, who often operate on separate network domains and often wish to access different network devices. This inconvenience and expense would result from an increased number of stock keeping unit (SKU) issues, distribution issues, and so forth.

What is desired is a technique or device that determines or derives a substantially fully qualified domain name without the disadvantages of the known techniques.

### BRIEF DESCRIPTION OF THE DRAWINGS

The claimed subject matter will be understood more fully from the detailed description given below and from the accompanying drawings of embodiments of the invention which, however, should not be taken to limit the claimed subject matter to the specific embodiments described, but are for explanation and understanding only.

FIG. 1 shows a flow chart diagram illustrating an embodiment of a technique in accordance with the claimed subject matter;

FIG. 2 shows a flow chart diagram illustrating an embodiment of a technique for deriving a network name in accordance with the claimed subject matter;

FIG. 3 shows a block diagram illustrating an embodiment of an apparatus for deriving a network name in accordance with the claimed subject matter.

### DETAILED DESCRIPTION

In the following detailed description, numerous details are set forth in order to provide a thorough understanding of the present claimed subject matter. However, it will be understood by those skilled in the art that the claimed subject matter may be practiced without these specific details. In other instances, well-known methods, procedures, components, and circuits have not been described in detail so as to not obscure the claimed subject matter.

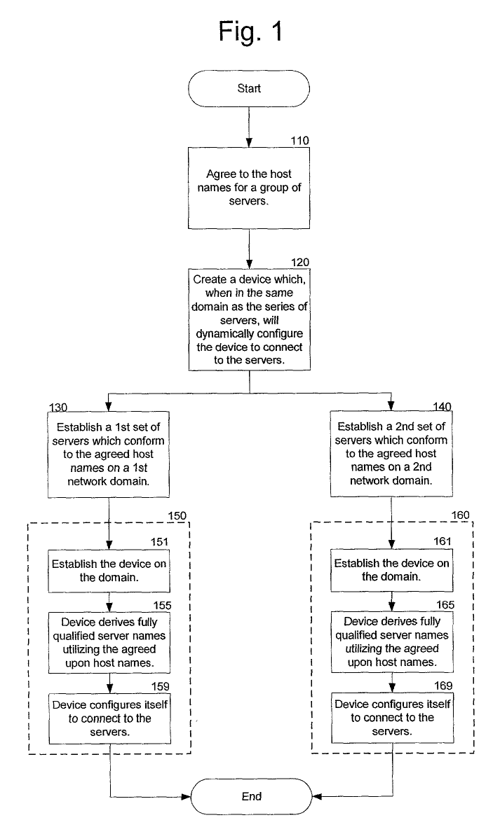

FIG. 1 illustrates an embodiment of a technique for reducing the stock-keeping units (SKUs) for a particular product. In this context, a SKU may be considered a separate “build” of a particular product that would result in increased distributor issues. As illustrated by action 110 of FIG. 1, an embodiment of such a technique may include reaching an agreement between two or more parties as to the host names of a type of servers which provide network resources. For example, action 110 may result in a standard, possibly formal or informal, that is agreed upon by two or more companies, individuals or groups, detailing which host names will correspond to a type of network servers.

As illustrated by action 120, a device is created which is capable of configuring itself to facilitate connecting to the above type of servers when placed on the same network domain as those servers. This device may be created by one of the parties to the host name agreement. However, it is contemplated that the device could be created by a party who was uninvolved in the agreement, such as, for example a sub-contractor or entrant into the market for the devices. The claimed subject matter is not limited to any specific parties.

Such a device might be created to utilize a variety of techniques to dynamically configure itself to facilitate connecting to the agreed upon types of servers. Because the host names of servers are agreed upon, the device may be, for example, preconfigured with those particular host names. When in operation and established upon a network domain, the device may determine the domain name of the network in which it is operating. The domain name of the device may be determined through a variety of techniques. One skilled in the art will realize which technique is most appropriate for the circumstances.

For example, a device may be dynamically assigned a network address when the device is first established on the network via, for example, the Dynamic Host Configuration Protocol (DHCP). Dromas, R., 1993 “Dynamic Host Configuration Protocol,” RFC 1541, 39 pages (October). This network address may then be translated into the fully qualified domain name assigned to the device (hereafter, “the fully qualified client name”). For example, this translation may be accomplished via a lookup table, such as, for example, that utilized by the Domain Name System (DNS). DNS is a distributed database used, often by Internet applications, to map network names to network addresses. Mockapetris, P. V. 1987a. “Domain Names: Concepts and Facilities,” RFC 1034, 55 pages (November). In this example, the device might request, from the DNS, the fully qualified client name corresponding to the network address that was previously assigned to the device. This fully qualified client name may then be truncated, possibly by removing the host name of the device, to create the domain name. Alternatively, the domain name may be statically assigned to the device by the user. One skilled in the art will understand that multiple techniques may be used to determine the domain name assigned to the device.

The device may then derive the fully qualified domain name of the server or servers (hereafter, “the fully qualified server name”) by appending one of the preconfigured agreed upon host names to the determined domain name. Once the fully qualified server name has been derived, the device may attempt to connect with the server. If the attempted connection cannot be made, the device may, for example, report an error or take another appropriate action. One skilled in the art will realize that this is merely one particular embodiment of how a device may be created which will, during operation, dynamically configure itself to facilitate connection to a series of servers that are on the same network domain and that other embodiments are possible.

Utilizing such a technique, a device may be created which can configure itself to operate without user or manufacture intervention in multiple network domains, and therefore reduce the number of product “builds” required by a manufacturer. One skilled in the art will understand that different levels of user or manufacture intervention may be desirable for a variety of reasons and may affect the design of the device. As an example, a company, such as, for example, XYZ Co. may, as illustrated in action 130, establish a set of servers, conforming to the host names agreed upon during action 110, on a particular domain, such as, for example, the xyz.com domain. Concurrently, a second company, such as, for example, ABC Co., may, as illustrated in action 140, establish a second set of servers, conforming to the host names agreed upon during action 110, on a second domain, such as, for example, the abc.com domain. If the device created as a result of action 120 is established on the xyz.com domain it may automatically configure itself to facilitate connection to one of the servers on that domain, such as, for example, if one of the agreed upon host names was “mail,” the device may configure itself for “mail.xyz.com.” This is illustrated in action 150. However, if the same device was established on the abc.com domain it might dynamically reconfigure itself to facilitate connection to a server on the new domain, such as, for example, “mail.abc.com.” This is illustrated in action 160. Therefore, a device may be created that will automatically configure itself to facilitate connection to a set of servers with agreed upon host names in differing domains. One skilled in the art will understand that other host names are possible and the concept may be extended to multiple domains and host names. One skilled in the art will also realize that a device and network of servers may be created that utilizes a subset to the host names agreed upon during action 110 and that action 110 may involve a series of agreements which may not be fully completed until after actions, such as, 150 or 160 are completed. In addition, it is understood that most network architectures allow network nodes to have more than one host name; therefore, it is contemplated that the set of servers in actions 130 and 150 may have multiple host names, only some of which may conform to the agreement of action 110. Also, other, non-conforming devices may be established upon the network domains of actions 130 and 150.

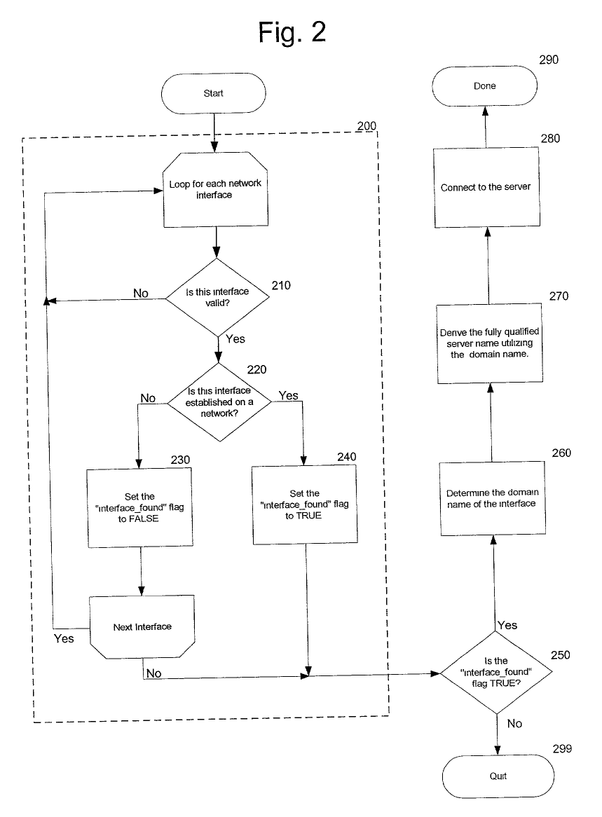

FIG. 2 illustrates an embodiment of a technique to derive a substantially fully qualified server name. Such a technique may be useful when, such as, for example, a device is connected to a network and knows the host name of a server it wishes to communicate with, but does not know the fully qualified server name of the server.

If an appropriate network interface for the device is found, the domain name that corresponds to this network interface may be determined, as illustrated by action 260 in FIG. 2. The domain name of the interface may be determined through a variety of techniques. One skilled in the art will realize which technique is most appropriate for the circumstances. For example, a network interface may be dynamically assigned a network address when the device is first established on the network via, for example, the Dynamic Host Configuration Protocol (DHCP). This network address may then be translated into the fully qualified domain name assigned to the network interface (hereafter, “the fully qualified client name”). For example, this translation may be accomplished via a lookup table, such as, for example, that utilized by the Domain Name System (DNS). In this example, the device might request, from the DNS, the fully qualified client name corresponding to the network address that was assigned to the device. This fully qualified client name may then be truncated, possibly by removing the host name of the network device, to create the domain name. Alternatively, the domain name may be statically assigned to the device by the user. One skilled in the art will understand that multiple techniques may be used to determine the domain name assigned to the network interface.

Utilizing the domain name assigned to the network interface, the substantially fully qualified domain name of a second network device (hereafter, “fully qualified server name”) may be derived, as illustrated by action 270 of FIG. 2. In one example, the first network device may be configured with the host name of a second network device. This host name may be configured to reside in, such as, for example, the instructions executed by the device or, in another example, the circuitry of the device. Possibly, in another example, the host name of the second device may be chosen from a list of predefined host names. Alternatively, the host name of the second network device may be dynamically input by the user. This host name may be appended to the domain name of the network interface to create the fully qualified server name. One skilled in the art will realize other possible techniques for deriving a fully qualified server name by utilizing, at least in part, the domain name of the network interface. One skilled in the art will also realize that the second network device need not be a server, it may, instead, be any device which is established or may be established on a network.

An additional embodiment of a technique to derive a substantially fully qualified domain name, may include establishing a network connection to the second network device, as illustrated by action 280 in FIG. 2. Additionally, an embodiment of the technique may include the determination of the proper network interface to utilize. Loop 200 in FIG. 2, illustrates iterating through multiple network interfaces until a proper network interface is found. The criteria to determine which network interface is proper may involve determining if the network interface is invalid, such as, for example, the “loopback” interface, as illustrated by action 210, or if the interface is properly established on the network, as illustrated by action 220. One skilled in the art will understand that a variety of techniques may be used to choose the proper network interface and the loop illustrated in FIG. 2 is merely one such example. Another embodiment of the technique may involve generating an error, as illustrated by action 299 of FIG. 2, or a different series of actions when no proper network interface is found.

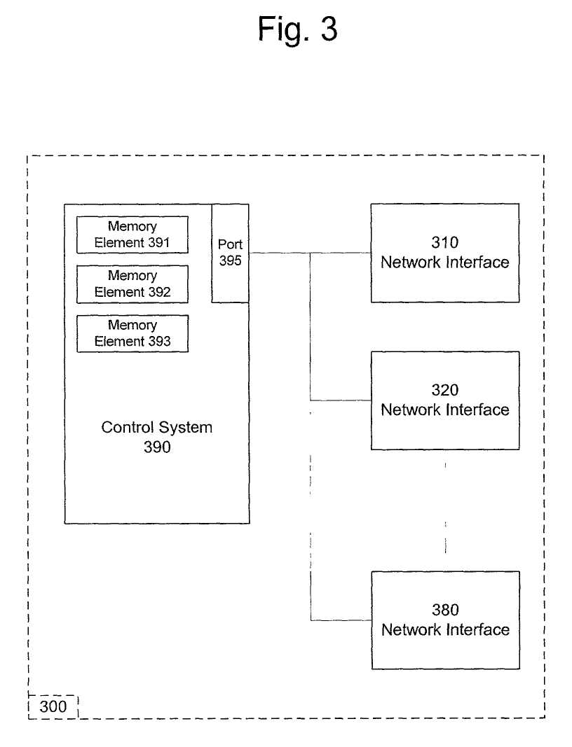

FIG. 3 illustrates an embodiment of a device, which, during operation, derives a substantially fully qualified server name. Device 300 may include communications port 395, which may be configured to communicate with network interface 310, and is coupled to control system 390. The control system may be capable, during operation, of deriving a substantially fully qualified server name. One skilled in the art will understand that the communications port may be configured to communicate with additional network interfaces 320-380. Such a port may take many forms, such as, for example, if the device is embedded in a network interface, the communication port may simply be a grouping of signals to the rest of the network interface, or, alternatively, the communication port may have a more formalized structure. One skilled in the art will understand that these are merely examples, and the port may take many forms.

In a specific embodiment, which the claimed subject matter is not limited to, the control system may include memory element 391, which, at least temporarily, holds a host name for a server. This host name may, for example, be preconfigured into the control system before the device is used by the consumer, or, in another example, the host name may be entered in the control system as a result of actions taken by the consumer. However, one skilled in the art will realize that the control system may obtain the host name through a variety of techniques.

The control system may also include memory element 392, which, at least temporarily, holds the domain name of the device. Upon activation, the device may determine, utilizing, for example, DHCP, which network it is part of and determine what network address it has been assigned. During operation, the control system may request the domain name of a given network interface. This may be accomplished, for example, by translating, via, for example, the DNS, the assigned network address into a fully qualified domain name and, subsequently, truncating the fully qualified domain name into a domain name. One skilled in the art will understand that the domain name may be requested from other sources, and that, information from which the domain name may be derived may be requested instead.

The control system may also include memory element 393, which, at least temporarily, holds the fully qualified server name for the server corresponding to the host name. The aforementioned memory elements containing the host name, domain name, and fully qualified server name may be coupled so as to, during operation, allow the control system to derive the fully qualified server name. The control system may utilize a variety of techniques to determine the fully qualified server name. For example, the control system may append the host name to the domain name. One skilled in the art will understand that the control system may be configured, either temporarily or permanently, to derive the fully qualified server name utilizing a variety of information. However, this is merely a specific example of the claimed subject matter; one skilled in the art will understand that other embodiments are possible.

In various embodiments, the network device may be embodied as a car radio, a radio or television for use in a home entertainment system, a cable/satellite set-top box, gaming console, cell phone, an Internet appliance, or other suitable system or format.

The reader should appreciate that drawings showing methods, and the written descriptions thereof, should also be understood to illustrate machine-accessible media having recorded, encoded, or otherwise embodied therein instructions, functions, routines, control codes, firmware, software, or the like, which, when accessed, read, executed, loaded into, or otherwise utilized by a machine, will cause the machine to perform the illustrated methods. Such media may include, by way of illustration only and not limitation: magnetic, optical, magneto-optical, or other storage mechanisms, fixed or removable discs, drives, tapes, semiconductor memories, organic memories, CD-ROM, CD-R, CD-RW, DVD-ROM, DVD-R, DVD-RW, Zip, floppy, cassette, reel-to-reel, or the like. They may alternatively include down-the-wire, broadcast, or other delivery mechanisms such as Internet, local area network, wide area network, wireless, cellular, cable, laser, satellite, microwave, or other suitable carrier means, over which the instructions etc. may be delivered in the form of packets, serial data, parallel data, or other suitable format. The machine may include, by way of illustration only and not limitation: microprocessor, embedded controller, PLA, PAL, FPGA, ASIC, computer, smart card, networking equipment, or any other machine, apparatus, system, or the like which is adapted to perform functionality defined by such instructions or the like. Such drawings, written descriptions, and corresponding claims may variously be understood as representing the instructions etc. taken alone, the instructions etc. as organized in their particular packet/serial/parallel/etc. form, and/or the instructions etc. together with their storage or carrier media. The reader will further appreciate that such instructions etc. may be recorded or carried in compressed, encrypted, or otherwise encoded format without departing from the scope of this patent, even if the instructions etc. must be decrypted, decompressed, compiled, interpreted, or otherwise manipulated prior to their execution or other utilization by the machine.

Reference to “subsequent” does not necessarily mean “immediately following”. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the claimed subject matter. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain features of the claimed subject matter have been illustrated and described herein, many modifications, substitutions, changes, and equivalents will now occur to those skilled in the art. It is, therefore, to be understood that the appended claims are intended to cover all such modifications and changes that fall within the true spirit of the claimed subject matter.

What is claimed is:

1. A method comprising:
determining a domain name of a device; and
deriving a substantially fully qualified server name utilizing the domain name.

2. The method of claim 1, wherein deriving a substantially fully qualified server name comprises utilizing a host name.

3. The method of claim 2, wherein utilizing a host name comprises utilizing a substantially predefined host name.

4. The method of claim 2, wherein deriving a substantially fully qualified server name comprises combining the domain name and the host name.

5. The method of claim 1, wherein determining a domain name of a device comprises utilizing a network address.

6. The method of claim 5, wherein utilizing a network address comprises utilizing an Internet Protocol address (IP address).

7. The method of claim 1, wherein determining a domain name of a device comprises utilizing a substantially fully qualified client name.

8. The method of claim 7, wherein determining a domain name of a device comprises converting a network address of the device into the substantially fully qualified client name.

9. The method of claim 8, wherein converting a network address of the device into the substantially fully qualified client name comprises utilizing a name server.

10. The method of claim 9, wherein utilizing a name server comprises utilizing a server which is substantially compliant with the Domain Name System (DNS).

11. The method of claim 7, wherein determining a domain name of a device comprises removing a host name from the substantially fully qualified client name.

12. The method of claim 1, further comprising making a network connection to the substantially fully qualified server name.

13. The method of claim 1, wherein determining a domain name of a device comprises choosing a network interface and determining the domain name associated with the network interface.

14. The method of claim 13, wherein choosing a network interface comprises choosing a single network interface from a group of network interfaces.

15. The method of claim 1, further comprising reporting an error if determining a domain name of a device cannot be accomplished.

16. A method comprising:
reaching an agreement between two or more parties as to the to the host names for a type of servers which provide network resources; and
creating a device which, when established on the same network domain as servers which conform to the agreed upon host names, may dynamically configure the device to facilitate connection to at least some of the servers on the network domain.

17. The method of claim 16, wherein creating a device comprises creating a device which is configured to utilize, during operation, the agreed upon host names for the series of servers.

18. The method of claim 17, wherein creating a device comprises creating a device which, during operation, dynamically determines the domain name of the network domain upon which the device is established.

19. The method of claim 18, wherein creating a device comprises creating a device which, during operation, dynamically derives the fully qualified server names of the at least some of the servers utilizing at least some of the agreed upon host names and the determined domain name.

20. The method of claim 17, wherein creating a device comprises preconfiguring the agreed upon host names into a memory element.

21. The method of claim 16, further comprising establishing, within a first network domain, a first set of servers which conform to the agreed upon host names.

22. The method of claim 21, further comprising establishing, within a second network domain, a second set of servers which conform to the agreed upon host names.

23. The method of claim 22, wherein creating a device comprises creating a device which,
when established on the first network domain, may dynamically configure the device to facilitate connection to the first set of servers and
when established on the second network domain, may dynamically configure the device to facilitate connection to the second set of servers.

24. The method of claim 22, wherein the first set of servers and the second set of servers comprises a different subset of the series of servers which provide network resources.

25. The method of claim 21, wherein the first set of servers conforms to the agreed upon host names and are assigned additional, alternative host names.

26. The method of claim 21, wherein one of the two or more parties creates the device, and another of the two or more parties establishes servers on a network.

27. The method of claim 21, wherein one of the two or more parties instructs a third party to create the device and another of the two or more parties instructs a fourth party to establish the servers on a network.

28. An apparatus comprising:
a communication port for communication with a network interface; and
a control system;
the communication port and the control system coupled in such a way as to, during operation, derive a substantially fully qualified server name.

29. The apparatus of claim 28, further comprising a network interface.

30. The apparatus of claim 28, wherein the communication port and the control system are coupled in such a way as to, during operation, to determine the domain name of the network interface.

31. The apparatus of claim 30, wherein the control system comprises a memory element to, at least temporarily store the domain name of the network interface.

32. The apparatus of claim 30, wherein the control system has a configuration so as to, during operation, generate the substantially fully qualified server name utilizing the domain name associated with the network interface and a host name.

33. The apparatus of claim 32, wherein the control system comprises a substantially predefined host name.

34. The apparatus of claim 33, wherein the control system comprises a memory element to, at least temporarily store the host name.

35. The apparatus of claim 32, wherein the control system has a configuration so as to, during operation, generate the substantially fully qualified server name by combining the domain name associated with the network interface and the host name.

36. The apparatus of claim 35, wherein the control system comprises a memory element to, at least temporarily store the substantially fully qualified server name.

37. The apparatus of claim 28, wherein the control system comprises a circuit specifically designed to generate the substantially fully qualified server name.

38. A machine accessible medium including thereon instructions which, when executed by a machine, cause the machine to perform a method comprising:
determining a domain name of a device; and
deriving a substantially fully qualified server name utilizing the domain name.

39. The method of claim 38, wherein deriving a substantially fully qualified server name comprises utilizing a host name.

40. The method of claim 39, wherein utilizing at least in part a host name comprises utilizing a substantially predefined host name.

41. The method of claim 39, wherein deriving a substantially fully qualified server name comprises combining the domain name and the host name.

42. The method of claim 38, wherein determining a domain name of a device comprises utilizing a network address.

43. The method of claim 42, wherein utilizing a network address comprises utilizing an Internet Protocol address (IP address).

44. The method of claim 38, wherein determining a domain name of a device comprises utilizing a substantially fully qualified client name.

45. The method of claim 44, wherein determining a domain name of a device comprises converting a network address of the device into the substantially fully qualified client name.

46. The method of claim 45, wherein converting a network address of the device into the substantially fully qualified client name comprises utilizing a name server.

47. The method of claim 46, wherein utilizing a name server comprises utilizing a server which is substantially compliant with the Domain Name System (DNS).

48. The method of claim 44, wherein determining a domain name of a device comprises removing a host name from the substantially fully qualified client name.

49. The method of claim 38, further comprising making a network connection to the substantially fully qualified server name.

50. The method of claim 38, wherein determining a domain name of a device comprises choosing a network interface and determining the domain name associated with the network interface.

51. The method of claim 50, wherein choosing a network interface comprises choosing a single network interface from a group of network interfaces.

52. The method of claim 38, further comprising reporting an error if determining a domain name of a device cannot be accomplished.
